(19) United States
(12) Patent Application Publication
(10) Pub. No.: US 2018/0361745 A1
(43) Pub. Date: Dec. 20, 2018

(54) PRINTHEAD ASSEMBLY

(71) Applicant: HEWLETT-PACKARD DEVELOPMENT COMPANY, L.P., Houston, TX (US)

(72) Inventors: Daniel W. PETERSEN, Corvallis, OR (US); David J. BENS0N, Corvallis, OR (US)

(21) Appl. No.: 15/748,589

(22) PCT Filed: Oct. 30, 2015
(86) PCT No.: PCT/US2015/058282

§ 371 Date: Jan. 29, 2018

(51) Int. Cl. B41J 2/16; B41J 2/175; B41J 2/14

(52) U.S. Cl. CPC B41J 2/1623; B41J 2/1603; B41J 2202/19; B41J 2/14072; B41J 2/1753

(57) ABSTRACT

A printhead assembly includes a substrate to support a printhead die and an electrical circuit electrically coupled to the printhead die, with the substrate including a support surface to support the printhead die, a first rail to support the electrical circuit, and a second rail to support an adhesive between the electrical circuit and the substrate.

### BACKGROUND

An inkjet printing system may include a printhead assembly, an ink supply which supplies ink to the printhead assembly, and an electronic controller which controls the printhead assembly. The printhead assembly may include a printhead die from which drops of ink are ejected for printing on a print media, and an electrical circuit connected with the printhead die by which the electronic controller communicates with the printhead die.

### BRIEF DESCRIPTION OF THE DRAWINGS

FIG. 1 is a block diagram illustrating an example of an inkjet printing system.

FIG. 2 is a schematic illustration of an example of a printhead assembly.

FIG. 3 is an exploded illustration of an example of a printhead assembly.

FIG. 4 is an exploded cross-sectional view of an example of a printhead assembly from the perspective of lines 4-4 of FIG. 3.

FIG. 5 is an assembled cross-sectional view of an example of a printhead assembly from the perspective of lines 4-4 of FIG. 3.

FIG. 6 is an enlarged view of a portion of an example of a printhead assembly as identified in FIG. 5.

FIGS. 7A, 7B, 7C are flow diagrams illustrating an example of a method of forming a printhead assembly.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure.

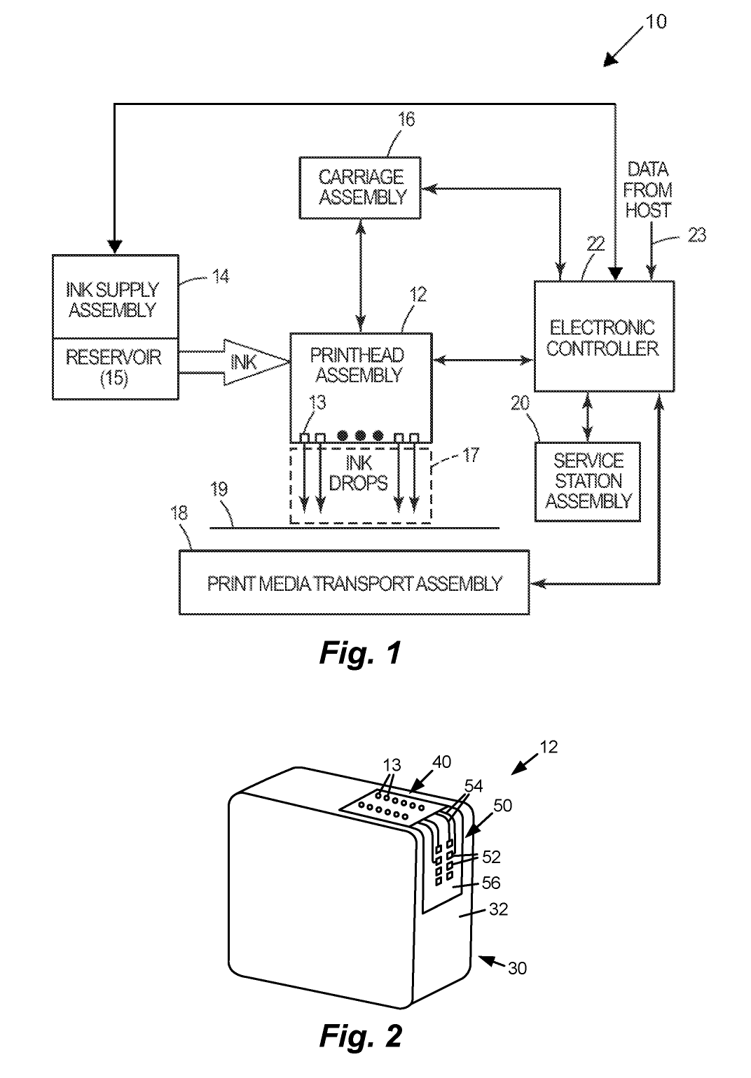

FIG. 1 illustrates an example of an inkjet printing system 10. Inkjet printing system 10 includes a fluid ejection assembly, such as printhead assembly 12, and a fluid supply assembly, such as ink supply assembly 14. In the illustrated example, inkjet printing system 10 also includes a carriage assembly 16, a print media transport assembly 18, a service station assembly 20, and an electronic controller 22.

Printhead assembly 12 includes printhead dies or fluid ejection devices which eject drops of printing fluid, such as ink, through a plurality of orifices or nozzles 13. While the following description refers to the ejection of ink from printhead assembly 12, it is understood that other liquids, fluids, or flowable materials may be ejected from printhead assembly 12.

In one example, the drops are directed toward a medium, such as print media 19, so as to print onto print media 19. In one implementation, nozzles 13 are arranged in columns or arrays such that properly sequenced ejection of ink from nozzles 13 causes characters, symbols, and/or other graphics or images to be printed upon print media 19 as printhead assembly 12 and print media 19 are moved relative to each other.

Print media 19 includes, for example, paper, card stock, envelopes, labels, transparent film, cardboard, rigid panels, and the like. In one example, print media 19 is a sheet material. In another example, print media 19 is a continuous form or continuous web material. As such, print media 19 may include a continuous roll of unprinted paper.

Ink supply assembly 14 supplies ink to printhead assembly 12 and includes a reservoir 15 for storing ink. As such, in one example, ink flows from reservoir 15 to printhead assembly 12. In one example, printhead assembly 12 and ink supply assembly 14 are housed together in an inkjet or fluid-jet print cartridge or pen. In another example, ink supply assembly 14 is separate from printhead assembly 12 and supplies ink to printhead assembly 12 through an interface connection, such as a supply tube.

Carriage assembly 16 positions printhead assembly 12 relative to print media transport assembly 18 and print media transport assembly 18 positions print media 19 relative to printhead assembly 12. Thus, a print zone 17 is defined adjacent to nozzles 13 in an area between printhead assembly 12 and print media 19. In one example, printhead assembly 12 is a scanning type printhead assembly such that carriage assembly 16 moves printhead assembly 12 relative to print media transport assembly 18. In another example, printhead assembly 12 is a non-scanning type printhead assembly such that carriage assembly 16 fixes printhead assembly 12 at a prescribed position relative to print media transport assembly 18.

Service station assembly 20 provides for spitting, wiping, capping, and/or priming of printhead assembly 12 in order to maintain a functionality of printhead assembly 12 and, more specifically, nozzles 13. For example, service station assembly 20 may include a rubber blade or wiper which is periodically passed over printhead assembly 12 to wipe and clean nozzles 13 of excess ink. In addition, service station assembly 20 may include a cap which covers printhead assembly 12 to protect nozzles 13 from drying out during periods of non-use. In addition, service station assembly 20 may include a spittoon into which printhead assembly 12 ejects ink to insure that reservoir 15 maintains an appropriate level of pressure and fluidity, and insure that nozzles 13 do not clog or weep. Functions of service station assembly 20 may include relative motion between service station assembly 20 and printhead assembly 12.

Electronic controller 22 communicates with printhead assembly 12, carriage assembly 16, print media transport assembly 18, and service station assembly 20. Thus, in one example, when printhead assembly 12 is mounted in carriage assembly 16, electronic controller 22 and printhead assembly 12 communicate via carriage assembly 16. Electronic controller 22 also communicates with ink supply assembly 14 such that, in one implementation, a new (or used) ink supply may be detected, and a level of ink in the ink supply may be detected.

Electronic controller 22 receives data 23 from a host system, such as a computer, and may include memory for temporarily storing data 23. Data 23 may be sent to inkjet printing system 10 along an electronic, infrared, optical or other information transfer path. Data 23 represents, for example, a document and/or file to be printed. As such, data 23 forms a print job for inkjet printing system 10 and includes print job commands and/or command parameters.

In one example, electronic controller 22 provides control of printhead assembly 12 including timing control for ejection of ink drops from nozzles 13. As such, electronic controller 22 defines a pattern of ejected ink drops which form characters, symbols, and/or other graphics or images on print media 19. Timing control and, therefore, the pattern of ejected ink drops, is determined by the print job commands and/or command parameters. In one example, logic and drive circuitry forming a portion of electronic controller 22 is located on printhead assembly 12. In another example, logic and drive circuitry forming a portion of electronic controller 22 is located off printhead assembly 12.

FIG. 2 is a schematic illustration of an example of a printhead assembly, such as printhead assembly 12, as described above. In one example, printhead assembly 12 includes a body or housing 30, a printhead die 40, and an electrical circuit 50. Printhead die 40 includes orifices or nozzles 13 such that drops of ink or fluid are ejected through nozzles 13, as described above. In one example, printhead die 40 may include a thin-film structure formed on a substrate. The substrate may be formed, for example, of silicon, glass, or a stable polymer, and the thin-film structure may include conductive, passivation or insulation layers.

In one example, housing 30 supports printhead die 40 and contains a reservoir of printing fluid, such as reservoir 15 (FIG. 1). As such, reservoir 15 communicates with printhead die 40 to supply printing fluid (e.g., ink) to printhead die 40. In addition, housing 30 supports electrical circuit 50 which facilitates communication of electrical signals between an electronic controller, such as electronic controller 20 (FIG. 1), and printhead die 40 for controlling and/or monitoring operation of printhead die 40.

In one example, electrical circuit 50 includes a plurality of electrical contacts 52 and a plurality of conductive paths 54 which extend between and provide electrical connection between electrical contacts 52 and printhead die 40. Electrical contacts 52 provide points for electrical connection to printhead assembly 12 and, more specifically, printhead die 40. As such, electrical contacts 52 facilitate communication of power, ground, and/or data signals with printhead die 40. In one example, electrical circuit 50 is supported by housing 30 such that electrical contacts 52 are provided along a side 32 of housing 30.

In one example, electrical circuit 50 is a flexible electrical circuit. As such, conductive paths 54 are formed in or on a flexible base material 56. Base material 56 may include, for example, a polyimide or other flexible polymer material (e.g., polyester, poly-methyl-methacrylate), and conductive paths 54 may be formed of copper, gold, or other conductive material.

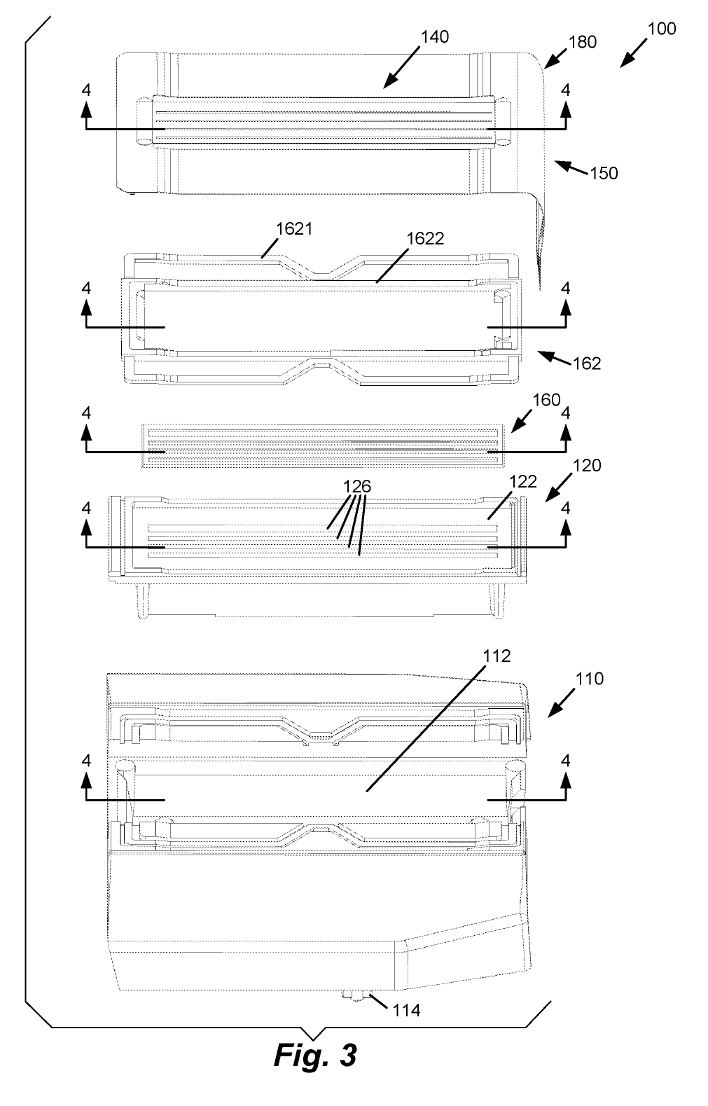

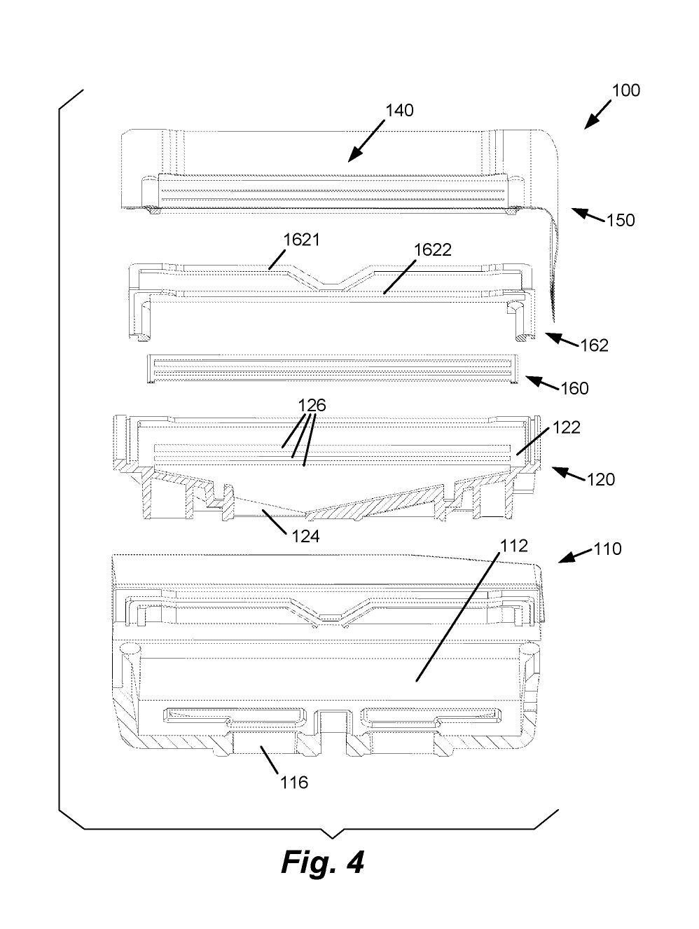

FIG. 3 is an exploded illustration of an example of a printhead assembly 100, and FIG. 4 is an exploded cross-sectional view of printhead assembly 100 from the perspective of lines 4-4 of FIG. 3. In one example, printhead assembly 100, as an example of printhead assembly 12 (FIG. 1) is formed of separate components including a base 110, a substrate 120, a printhead die 140, as an example of printhead die 40, and an electrical circuit 150, as an example of electrical circuit 50. Base 110 and substrate 120 mate with each other and are configured such that base 110 and substrate 120 provide mechanical support for and accommodate fluidic routing to printhead die 140, as described below.

In one example, base 110 includes a pocket 112 into which substrate 120 is fit or received. Pocket 112 is sized and configured to receive and support substrate 120. Although base 110 is illustrated and described as having one pocket, base 110 may have any number of pockets 112 each receiving and supporting a respective substrate 120.

In one example, base 110 includes a fluid port 114 through which printing fluid from a fluid supply, such as ink from ink supply assembly 14, is communicated with printhead assembly 100. In one implementation, base 110 includes a fluid passage 116 (FIG. 4) communicated with fluid port 114 (FIG. 3) such that printing fluid (e.g., ink) is communicated with printhead die 140 through base 110, as described below.

In one example, substrate 120 has or provides a support surface 122 for printhead die 140, as described below. In addition, in one example, substrate 120 has a fluid passage 124 (or multiple fluid passages 124) formed therein, and has a series of fluid slots 126 formed in support surface 122. Fluid passage 124 and fluid slots 126 communicate with and provide fluidic routing for printhead die 140, as described below. As such, in one example, substrate 120 is secured or mounted within pocket 112 so as to provide a fluid-tight seal with base 110.

In one example, substrate 120 is formed of a plastic, ceramic, glass, or other suitable material. When substrate 120 is formed of a plastic material, filler materials such as glass, carbon fibers, minerals, or other suitable filler materials may also be used. In addition, substrate 120 can be formed by a number of methods such as injection molding, pressing, machining, or etching depending on the substrate material.

In one example, printhead die 140 is joined with or mounted on electrical circuit 150 such that printhead die 140 and electrical circuit 150 are together supported by substrate 120 and base 110. In one example, printhead die 140 is mounted on substrate 120 so as to communicate with fluid slots 126 such that fluid slots 126 provide fluid to printhead die 140 through substrate 120. As such, printhead die 140 and electrical circuit 150 are secured to or mounted on substrate 120 and base 110 so as to provide a fluid-tight seal with substrate 120 and base 110.

In one example, printhead die 140 is secured to or mounted on substrate 120 with an adhesive 160 provided between printhead die 140 and substrate 120, as described below, and electrical circuit 150 is secured to or mounted on base 110 and substrate 120 with an adhesive 162 provided between electrical circuit 150 and base 110, and between electrical circuit 150 and substrate 120, as described below. In one example, adhesive 162 is a “merged” adhesive in that adhesive 162 includes an adhesive 1621 provided between electrical circuit 150 and base 110, and an adhesive 1622 provided between electrical circuit 150 and substrate 120. In one example, adhesive 160 and/or adhesive 162 is selected to help absorb stresses which otherwise may be imparted to printhead die 140.

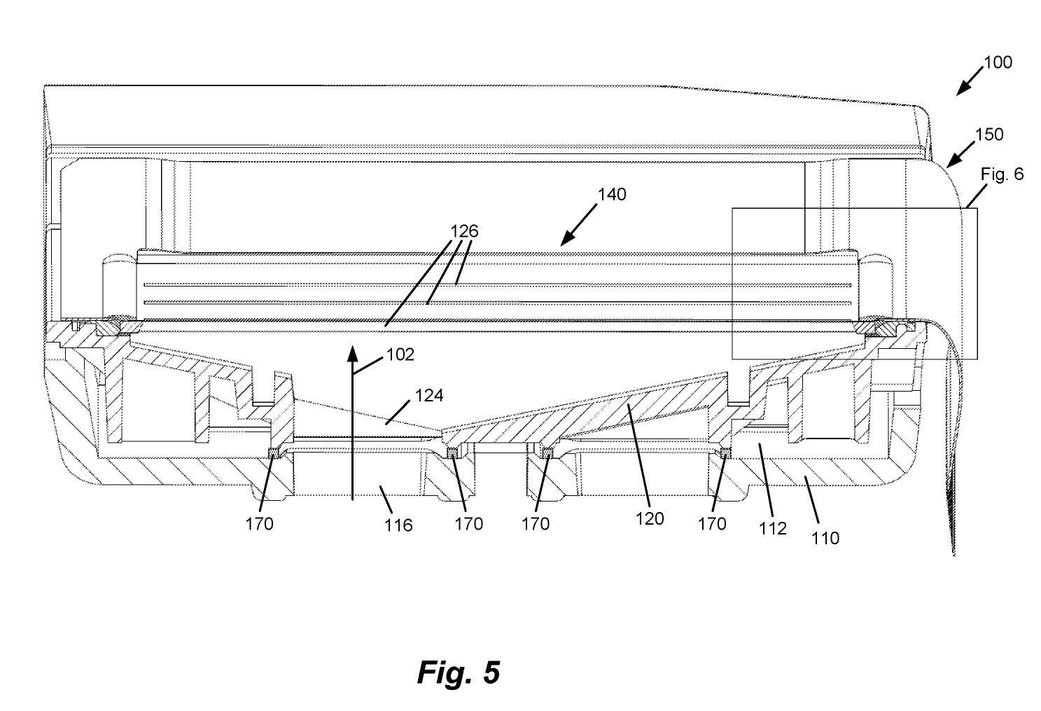

FIG. 5 is an assembled cross-sectional view of printhead assembly 100 from the perspective of lines 4-4 of FIG. 3. As illustrated in the example of FIG. 5, substrate 120 is fit or received within pocket 112 of base 110, and printhead die 140 and electrical circuit 150 are supported by substrate 120 and base 110. In one example, substrate 120 is secured to or mounted within pocket 112 of base 110 so as to provide a fluid-tight seal with base 110. For example, in one implementation, an adhesive 170 forms a fluid-tight seal between base 110 and substrate 120. As such, in one example, fluid flow or fluid routing, as identified by arrow 102, is provided through fluid passage 116, through fluid passage 124, and through fluid slot (or slots) 126 to printhead die 140.

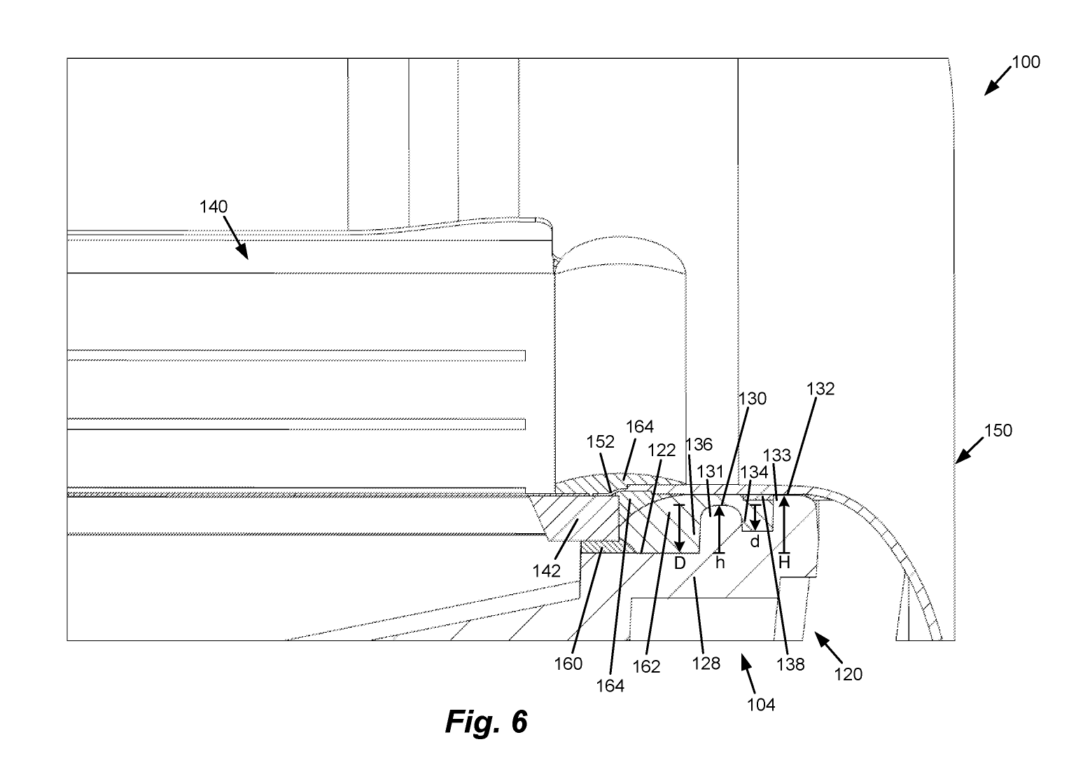

FIG. 6 is an enlarged view of a portion of printhead assembly 100, as identified in FIG. 5, and illustrates a headland 104 of printhead assembly 100. In one example, headland 104 includes an area or region of printhead assembly 100 where substrate 120, printhead die 140, and electrical circuit 150 are supported, mounted, secured and/or joined.

In one example, headland 104 includes an end 128 of substrate 120. In one example, end 128 extends over base 110 (FIG. 5), and provides support for printhead die 140 and electrical circuit 150. More specifically, in one example, end 128 of substrate 120 includes support surface 122 for printhead die 140, a support surface 130 for adhesive 162, and a support surface 132 for electrical circuit 150. In one example, support surface 130 is adjacent and positioned outward of support surface 122, and support surface 132 is spaced from and positioned outward of support surface 130.

In one example, support surface 130 is formed by a protrusion or rail 131, and support surface 132 is formed by a protrusion or rail 133. In one example, rail 131 extends to or provides a height h relative to support surface 122, and rail 133 extends to or provides a height H relative to support surface 122 such that, in one example, height h is less than height H.

In one example, rail 133 is provided at or along an edge of substrate 120, and rail 131 is spaced from and provided inward of rail 133. As such, in one example, a recessed area or gutter 134 for adhesive 162 is provided between rail 131 and 133. In addition, in one example, rail 131 extends from support surface 122 such that support surface 122 forms an additional recessed area or gutter 136 for adhesive 162. As such, in one example, gutter 134 is provided to one side (outward) of rail 131, and gutter 136 is provided to an opposite side (inward) of rail 131. In one example, gutter 134 is provided to a depth d and gutter 136 is provided to a depth D such that depth D is greater than depth d.

In one example, as illustrated in FIG. 6, electrical circuit 150 is electrically coupled to printhead die 140 by electrical leads 152 (only one of which is illustrated). In one example, electrical leads 152 extend from electrical circuit 150 and are electrically coupled to an end 142 of printhead die 140.

In one example, electrical leads 152 are protected or encapsulated by an encapsulant material 164. In one example, encapsulant material 164 is provided to cover one side of electrical leads 152, an adjacent portion of a corresponding side of electrical circuit 150, and an adjacent portion of a corresponding side of printhead die 140. In addition, in one example, encapsulant material 164 is provided to cover an opposite side of electrical leads 152, an adjacent portion of a corresponding opposite side of electrical circuit 150, and an adjacent portion of end 142 of printhead die 140. As such, encapsulant material 164 helps to isolate electrical leads 152 from ink, and helps to span or fill gaps between printhead die 140 and electrical circuit 150.

As illustrated in the example of FIG. 6, printhead die 140 is supported by substrate 120. More specifically, printhead die 140 is mounted on support surface 122 of substrate 120, and is secured to support surface 122 by adhesive 160. In one example, with printhead die 140 mounted on substrate 120, support surface 122 extends beyond end 142 of printhead die 140. As such, a space or gap is provided or formed between printhead die 140 and rail 131 such that gutter 136 is established between printhead die 140 and rail 131.

As illustrated in the example of FIG. 6, electrical circuit 150 is supported by substrate 120. More specifically, electrical circuit 150 is mounted on support surface 132 of substrate 120, and is secured to support surface 130 by adhesive 162. In one example, adhesive 162 is applied to support surface 130 as established by rail 131, and fills (partially or fully) gutter 134, as provided between rail 131 and rail 133, and fills (partially or fully) gutter 136, as provided between rail 131 and end 142 of printhead die 140. As such, adhesive 162 secures electrical circuit 150 to substrate 120. In addition, in one example, adhesive 162 provides support to encapsulant material 164 and, more specifically, the electrical connection between electrical circuit 150 and printhead die 140. In one example, support surface 132, as defined by rail 133, helps to set or establish a position of electrical circuit 150, including, more specifically, a height of electrical circuit 150 (and printhead die 140 as combined with electrical circuit 150) relative to substrate 120. In one example, an attach material or member 138 is provided to facilitate attachment or securing of electrical circuit 150 to and/or with rail 133.

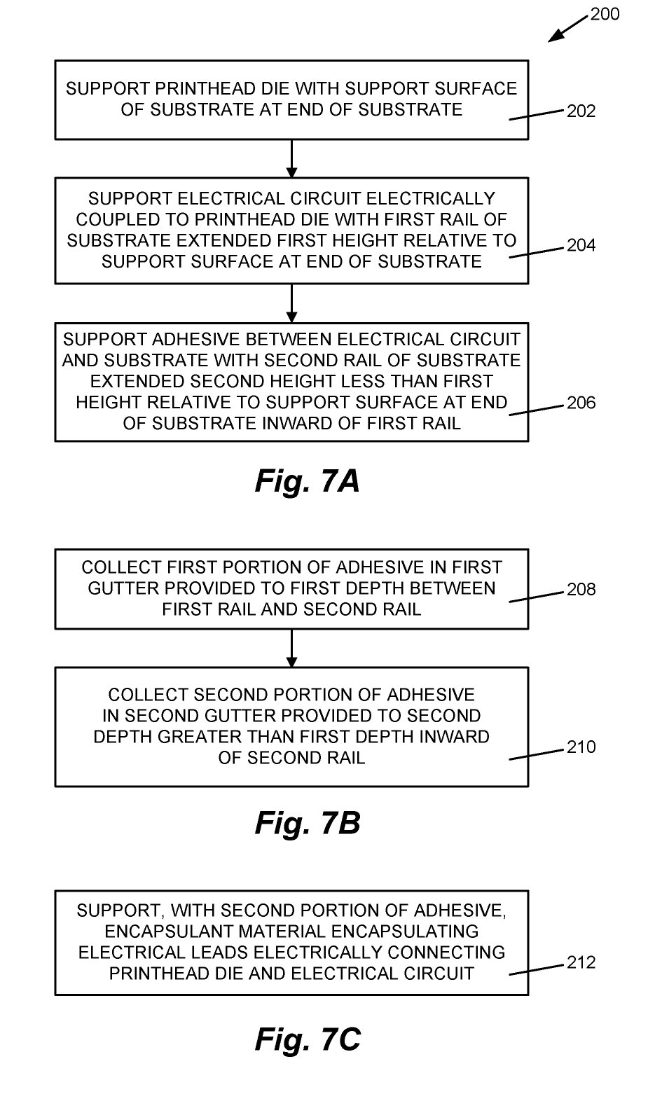

FIGS. 7A, 7B, 7C are flow diagrams illustrating an example of a method of forming a printhead assembly, such as printhead assembly 100, as illustrated, for example, in FIGS. 3, 4, 5, 6.

In one example, as illustrated in FIG. 7A, at 202, method 200 includes supporting a printhead die, such as printhead die 140, with a support surface of a substrate, such as support surface 122 of substrate 120, at an end of the substrate, such as end 128 of substrate 120, as illustrated, for example, in FIGS. 5, 6.

At 204, method 200 includes supporting an electrical circuit electrically coupled to the printhead die, such as electrical circuit 150, with a first rail of the substrate, such as rail 133, extended a first height relative to the support surface, such as height H, at the end of the substrate, such as end 128 of substrate 120, as illustrated, for example, in FIGS. 5, 6.

At 206, method 200 includes supporting an adhesive between the electrical circuit and the substrate, such as adhesive 162, with a second rail of the substrate, such as rail 131, extended a second height less than the first height relative to the support surface, such as height h, at the end of the substrate, such as end 128 of substrate 120, inward of the first rail, such as rail 133, as illustrated, for example, in FIGS. 5, 6.

In one example, as illustrated in FIG. 7B, at 208, method 200 includes collecting a first portion of the adhesive in a first gutter provided to a first depth between the first rail and the second rail, such as gutter 134 provided to depth d between rail 133 and rail 131, as illustrated, for example, in FIGS. 5, 6.

And, at 210, method 200 includes collecting a second portion of the adhesive in a second gutter provided to a second depth greater than the first depth inward of the second rail, such as gutter 136 provided to depth D inward of rail 131, as illustrated, for example, in FIGS. 5, 6.

In one example, as illustrated in FIG. 7C, at 212, with method 200, collecting the second portion of the adhesive in the second gutter, for example, at 210, includes supporting, with the second portion of the adhesive, such as adhesive 162, an encapsulant material encapsulating electrical leads electrically connecting the printhead die and the electrical circuit, such as encapsulant material 164 encapsulating electrical leads 152, as illustrated, for example, in FIGS. 5, 6.

Although illustrated and described as separate and/or sequential steps, method 200 of forming a printhead assembly, such as printhead assembly 100, may include a different order or sequence of steps, and may combine one or more steps or perform one or more steps concurrently, partially or wholly. For example, in one implementation, as described above, printhead die 140 is joined with or mounted on electrical circuit 150 such that printhead die 140 and electrical circuit 150 are together supported by substrate 120 and base 110. More specifically, in one example, as described above, electrical circuit 150 is electrically coupled to printhead die 140 by electrical leads 152, and electrical leads 152 are encapsulated by encapsulant material 164. As such, in one example, printhead die 140 is mechanically coupled to electrical circuit 150 by encapsulant material 164 before printhead die 140 and electrical circuit 150 are supported by and/or mounted on substrate 120. Thus, in one implementation, printhead die 140, electrical circuit 150, and encapsulant material 164 form a sub-assembly 180 (FIG. 3) for printhead assembly 100.

Accordingly, in one implementation, with method 200, supporting a printhead die with a support surface of a substrate, supporting an electrical circuit electrically coupled to the printhead die with a first rail of the substrate, and supporting an adhesive between the electrical circuit and the substrate with a second rail of the substrate, for example, at 202, 204, and 206, respectively, includes dispensing adhesives 160 and 162, for example, on support surface 122 and rail 131, respectively, placing and aligning sub-assembly 180, for example, on rail 133 (and other portions of base 110), partially curing adhesive 162 in the proximity of rails 131 and 133 (and other portions of base 110), for example, with a heat stake shoe, and completely curing adhesives 160 and 162, for example, by hot air cure. As such, sub-assembly 180, including printhead die 140, electrical circuit 150, and encapsulant material 164, is supported by and secured to substrate 120.

In some examples, providing a printhead assembly with a headland as described and illustrated helps facilitate a more reliable mounting of a printhead die and an electrical circuit electrically coupled to the printhead die to a substrate. For example, by providing the headland with support surfaces as described and illustrated, including rails and gutters as described and illustrated, the printhead die and the electrical circuit may be more effectively supported by and secured to the substrate. Forming the support surfaces, including the rails and gutters, on or with a single component, namely, the substrate, helps to eliminate potential stresses which may result if instead multiple components were used. In addition, providing support to the encapsulation material as described and illustrated helps to reduce potential failures at the connection of the printhead die and the electrical circuit, as such failures may allow ink ingress and corrosion which could lead to failure of the printhead die.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein.

1. A printhead assembly, comprising:
a substrate to support a printhead die and an electrical circuit electrically coupled to the printhead die,
the substrate including a support surface to support the printhead die, a first rail to support the electrical circuit, and a second rail to support an adhesive between the electrical circuit and the substrate.

2. The printhead assembly of claim 1, the electrical circuit to be electrically coupled to an end of the printhead die, and the support surface for the printhead die to extend beyond the end of the printhead die.

3. The printhead assembly of claim 1, wherein the first rail is at an edge of the substrate, and the second rail is spaced from and inward of the first rail.

4. The printhead assembly of claim 1, wherein, relative to the support surface for the printhead die, a height of the second rail is less than a height of the first rail.

5. The printhead assembly of claim 1, further comprising:
the substrate including a gutter between the first rail and the second rail to collect adhesive.

6. The printhead assembly of claim 5, wherein the gutter is provided to one side of the second rail, and further comprising:
the substrate including another gutter to an opposite side of the second rail to collect adhesive.

7. A printhead assembly, comprising:
a substrate having a fluid slot formed therein;
a printhead die supported by the substrate and fluidically communicated with the fluid slot; and
an electrical circuit supported by the substrate and electrically coupled with the printhead die,
an end of the substrate having a first support surface to support the printhead die, a second support surface extended to a first height relative to the first support surface to support the electrical circuit, and a third support surface extended to a second height less than the first height relative to the first support surface to support an adhesive between the electrical circuit and the substrate.

8. The printhead assembly of claim 7, further comprising:
a base,
the substrate received within the base, and the end of the substrate extended over the base.

9. The printhead assembly of claim 7, further comprising:
the substrate having a first recessed area to a first depth at a first side of the third support surface, and a second recessed area to a second depth greater than the first depth at a second side of the third support surface.

10. The printhead assembly of claim 9, wherein the first recessed area is between the second support surface and the third support surface.

11. The printhead assembly of claim 7, wherein the third support surface is adjacent and positioned outward of the first support surface, and the second support surface is spaced from and positioned outward of the third support surface.

12. The printhead assembly of claim 7, wherein the electrical circuit is electrically coupled to the printhead die by electrical leads encapsulated by an encapsulant material, wherein the adhesive between the electrical circuit and the substrate supports the encapsulant material.

13. A method of forming a printhead assembly, comprising:
supporting a printhead die with a support surface of a substrate at an end of the substrate;
supporting an electrical circuit electrically coupled to the printhead die with a first rail of the substrate extended a first height relative to the support surface at the end of the substrate; and
supporting an adhesive between the electrical circuit and the substrate with a second rail of the substrate extended a second height less than the first height relative to the support surface at the end of the substrate inward of the first rail.

14. The method of claim 13, further comprising:
collecting a first portion of the adhesive in a first gutter provided to a first depth between the first rail and the second rail; and
collecting a second portion of the adhesive in a second gutter provided to a second depth greater than the first depth inward of the second rail.

15. The method of claim 14, wherein collecting the second portion of the adhesive in the second gutter includes supporting, with the second portion of the adhesive, an encapsulant material encapsulating electrical leads electrically connecting the printhead die and the electrical circuit.
